(19) United States
(12) Patent Application Publication
(10) Pub. No.: US 2024/0044025 A1
(43) Pub. Date: Feb. 8, 2024

(54) POROUS TiO2-x-BASED CATALYST GROWN IN SITU AND METHOD OF PREPARING THE SAME

(71) Applicant: Daegu Gyeongbuk Institute of Science and Technology, Daegu (KR)

(72) Inventors: Jong Sung YU, Seoul (KR); Tong Hyun Kang, Seongnam-si (KR)

(73) Assignee: Daegu Gyeongbuk Institute of Science and Technology, Daegu (KR)

(21) Appl. No.: 18/366,025

(22) Filed: Aug. 7, 2023

(30) Foreign Application Priority Data
Aug. 5, 2022 (KR) 10-2021-0016777

(51) Int. Cl. C25B 11/067; C25B 11/077

(52) U.S. Cl. CPC C25B 11/067; C25B 11/077

(57) ABSTRACT

Provided is a catalyst for oxygen evolution reaction (OER) which has excellent catalytic performance and durability of oxygen evolution reaction (OER) by applying an oxide of divalent titanium having high electrical conductivity as a support, and more particularly, a porous catalyst for oxygen evolution reaction (OER) including a porous titanium oxide support satisfying TiO₂₋ₓ (0.1≤x<2); and a metal hydroxide supported on the titanium oxide support, and a method of preparing the same are provided.

### TECHNICAL FIELD

The present invention relates to a porous TiO₂₋ₓ-based catalyst grown in situ which has excellent catalytic activity and durability and a method of preparing the same.

### BACKGROUND ART

In order to replace current fossil fuels, various renewable energy sources including environmentally friendly and sustainable solar or wind energy are being considered. However, the energy sources do not have constant energy efficiency due to the influence of the surrounding environment and the efficiency is also still low.

As such, an in-depth study of renewable energy sources which are not affected by external environments such as weather is underway, and as one of the alternatives, hydrogen generated by electrolysis of water is in the limelight as the cleanest energy among next-generation energies. However, water electrolysis includes a hydrogen evolution reaction (HER) and an oxygen evolution reaction (OER), and the OER reaction of these is limited due to a slow reaction speed and a study of a catalyst for activating the reaction is needed for solving the problem. Commercially available OER catalysts use precious metals and have a problem of weak durability, and in order to solve the problem, Korean Patent Laid-Open Publication No. 10-2020-0137850 provides a non-platinum-based catalyst using carbon as a support and Non-Patent Document 1 provides an IrO₂ catalyst using TiO₂ as a support.

However, a carbon-based catalyst causes carbon activation at a potential lower than an OER activation potential to have a durability problem due to carbon corrosion caused by an oxidation reaction of a carbon support, while in an OER catalyst using TiO₂ as a support, since charge carriers do not move freely due to low electrical conductivity, catalytic performance is limited. In addition, the preparation process is complicated.

Therefore, an OER catalyst which is prepared by a preparation method simpler than a conventional preparation method in developing an OER catalyst which may not use or use a significantly decreased amount of precious metals and secure both durability and catalytic performance needs to be provided.

### RELATED ART DOCUMENT

### Patent Document

(Patent Document 1) Korean Patent Laid-Open Publication No. 10-2020-0137850

### Non-Patent Document

(Non-patent document 1) 1 Lu et al, Investigation on IrO2 supported on hydrogenated TiO2 nanotube array as OER electro-catalyst for water electrolysis, International Journal of Hydrogen Energy Volume 42, Issue 6, Pages 3565-3898 (9 Feb. 2017)

### DISCLOSURE

### Technical Problem

An object of the present invention is to provide a catalyst for oxygen evolution reaction having excellent oxygen evolution reaction activity and durability.

Another object of the present invention is to provide a method of preparing a catalyst for oxygen evolution reaction, which has a reduced process compared with a conventional method.

### Technical Solution

In one general aspect, a porous catalyst for oxygen evolution reaction (OER) includes: a porous titanium oxide support satisfying TiO₂₋ₓ (0.1≤x<2); and a metal hydroxide supported on the titanium oxide support.

In the catalyst for oxygen evolution reaction according to an exemplary embodiment of the present invention, the titanium oxide support may be a cubic crystal phase.

In the catalyst for oxygen evolution reaction according to an exemplary embodiment of the present invention, an electrical conductivity of the titanium oxide support at a pressure of 20 MPa may be 2 to 10 S/cm.

In the catalyst for oxygen evolution reaction according to an exemplary embodiment of the present invention, the titanium oxide support may satisfy TiO₂₋ₓ (0.7≤x≤1.3).

In the catalyst for oxygen evolution reaction according to an exemplary embodiment of the present invention, the metal hydroxide may be plate-shaped and loaded on the titanium oxide support.

In the catalyst for oxygen evolution reaction according to an exemplary embodiment of the present invention, the metal hydroxide may be a hydroxide of divalent metal.

In the catalyst for oxygen evolution reaction according to an exemplary embodiment of the present invention, the divalent metal may be one or more selected from Ca, Mg, Ni, Mo, Ru, Ir, Mn, Zn, Fe, Co, and Cu.

In the catalyst for oxygen evolution reaction according to an exemplary embodiment of the present invention, the metal hydroxide may be a metal layered double hydroxide (LDH) composite.

In the catalyst for oxygen evolution reaction according to an exemplary embodiment of the present invention, the metal layered double hydroxide composite may contain a divalent metal or a trivalent metal.

In the catalyst for oxygen evolution reaction according to an exemplary embodiment of the present invention, the catalyst for oxygen evolution reaction may contain 7 to 30 atom % of the divalent metal and the trivalent metal.

In the catalyst for oxygen evolution reaction according to an exemplary embodiment of the present invention, an atomic ratio of the divalent metal:the trivalent metal contained in the catalyst for oxygen evolution reaction may be 1:0.01 to 0.5.

In the catalyst for oxygen evolution reaction according to an exemplary embodiment of the present invention, the catalyst for oxygen evolution reaction may maintain catalytic performance of 90% or more for 100 hours after an accelerated degradation test (ADT).

In the catalyst for oxygen evolution reaction according to an exemplary embodiment of the present invention, the catalyst for oxygen evolution reaction may maintain the catalytic performance of 90% or more for 20 hours at a potential to which a high current density based on 50 mA/cm² is applied, after the accelerated degradation test (ADT).

In another general aspect, a method of preparing the catalyst for oxygen evolution reaction is provided.

The method of preparing a catalyst for oxygen evolution reaction includes: (a) preparing a composite formed of a porous titanium oxide support satisfying TiO₂₋ₓ (0.1≤x<2) and a metal (1) oxide in which a metal (1) is oxidized by a thermal reduction method from a mixture of anatase phase titanium dioxide (a-TiO₂) and the metal (1) as a reducing agent; (b) reacting the composite with an aqueous solution including an ion of a metal (2) having oxygen evolution reaction activity to prepare a metal (2) hydroxide supported on the titanium oxide support which is reduced by a hydration reaction of the metal (1) oxide and an ion exchange reaction between metals.

In the method of preparing a catalyst for oxygen evolution reaction according to an exemplary embodiment of the present invention, in (b), the metal (2) hydroxide may grow inside through a pore channel of the titanium oxide support.

In the method of preparing a catalyst for oxygen evolution reaction according to an exemplary embodiment of the present invention, the metal (1) as a reducing agent may be one or more selected from the group consisting of Mg, Al, Mn, Ca, Sn, Zn, Sb, Ag, Cu, Ni, Fe, Co, and Si.

In the method of preparing a catalyst for oxygen evolution reaction according to an exemplary embodiment of the present invention, the thermal reduction method may be performed at 300 to 1500° C.

In the method of preparing a catalyst for oxygen evolution reaction according to an exemplary embodiment of the present invention, the titanium oxide support may satisfy cubic crystalline phase TiO₂₋ₓ (0.7≤x≤1.3).

In the method of preparing a catalyst for oxygen evolution reaction according to an exemplary embodiment of the present invention, the ion of the metal (2) included in the aqueous solution in (b) may be an ion of a divalent metal.

In the method of preparing a catalyst for oxygen evolution reaction according to an exemplary embodiment of the present invention, the ion of the divalent metal may include one or more metal cations selected from Ca²⁺, Mg²⁺, Mo²⁺, Ru²⁺, Ir²⁺, Ni²⁺, Mn²⁺, Zn²⁺, Fe²⁺, Co²⁺, and Cu²⁺.

In the method of preparing a catalyst for oxygen evolution reaction according to an exemplary embodiment of the present invention, the ion exchange reaction may be performed for 1 to 48 hours so that a plate shaped metal (2) hydroxide may grow.

In the method of preparing a catalyst for oxygen evolution reaction according to an exemplary embodiment of the present invention, the hydration reaction, the ion exchange reaction, and growth of the metal (2) hydroxide in (b) may proceed in-situ.

In the method of preparing a catalyst for oxygen evolution reaction according to an exemplary embodiment of the present invention, doping the metal (2) hydroxide supported on the titanium oxide support with divalent and trivalent metal (3) ions may be further included after (b).

In the method of preparing a catalyst for oxygen evolution reaction according to an exemplary embodiment of the present invention, the doping with the divalent and trivalent metal (3) ions may be performed by an electrochemical activation process.

In the method of preparing a catalyst for oxygen evolution reaction according to an exemplary embodiment of the present invention, a metal layered double hydroxide (LDH) composite may be supported on the titanium oxide support by doping with the divalent and trivalent metal (3) ions.

### Advantageous Effects

The catalyst for oxygen evolution reaction (OER) provided in an aspect of the present invention may have significantly improved durability as compared with a commercially available OER catalyst supported on a carbon-based support while having catalytic performance equivalent to or better than that of a conventional catalyst, by applying an oxide of divalent titanium having high electrical conductivity as a support.

### DESCRIPTION OF DRAWINGS

The above and other objects, features and advantages of the present invention will become apparent from the following description of preferred embodiments given in conjunction with the accompanying drawings, in which:

FIG. 1 is a schematic diagram which schematically shows a process of preparing a catalyst for oxygen evolution reaction according to an exemplary embodiment of the present invention.

In FIG. 2, (a) shows an XRD pattern of Preparation Example 1, (b) is a STEM image of Preparation Example 1 of the present invention, and (c), (d), and (e) show mapping images of Ti, Mg, and O elements for TiO—MgO of Preparation Example 1, respectively.

In FIG. 3, (a) and (b) show UV-Vis spectra and Tauc plots of a-TiO₂ and Preparation Example 2, respectively, and (c) is a graph showing electrical conductivities of a-TiO₂, Preparation Example 2, and carbon black (Vulcan XC-72R, VC) in the present invention.

In FIG. 4, (a) shows an XRD pattern of Examples 1 to 3, and (b), (c), and (d) are FE-SEM images of Examples 1, 2, and 3, respectively.

In FIG. 5, (a) shows N₂ adsorption/desorption curves of Preparation Example 2 and Examples 1 to 3, and (b) shows pore size distribution (PSD) curves.

In FIG. 6, (a), (b), and (c) are SEM, TEM, and fast Fourier transform (FFT) images of Example 3, and (d), (e), and (f) are SEM, TEM, and FFT images of Example 6, respectively.

In FIG. 7, (a) shows a high-angle annular dark field-TEM (HAADF-TEM) image of Example 3 and mapping images for Ti, Ni, and O elements corresponding thereto, and (b) is a HAADF-TEM image of Example 6 and mapping images of Ti, Ni, O, and Fe elements corresponding thereto.

In FIG. 8, (a) and (b) show a profile of carrying out Raman spectroscopic analysis in a low Raman shift range and a high Raman shift range, respectively, of Examples 3 and 6.

FIG. 9 is a drawing illustrating the results of X-ray photoelectron spectroscopic analysis (XPS) of Examples 3 and 6.

In FIG. 10, (a), (b), and (c) show a linear sweep voltammetry (LSV) profile, the results of cyclic voltammetry (CV) experimentation, and the results of electrochemical impedance spectroscopy (EIS) measurement of Preparation Example 2, Examples 1 to 3, and commercially available RuO₂ supported on carbon black, respectively, and (d), (e), and (f) show a LSV profile, a CV profile, and the results of electrochemical impedance spectroscopy (EIS) measurement of Examples 3 to 7, respectively.

In FIG. 11, (a) shows a LSV profile of commercially available RuO₂ supported on carbon black, Preparation Example 2, Example 3, and Example 6 which were coated on a nickel (Ni) foam (NF), and a nickel foam itself, respectively, and (b) is a drawing illustrating the results of chronoamperometry which proceeded on commercially available RuO₂ supported on carbon black and Example 6 which were coated on a nickel foam, for 50 hours and 100 hours, respectively.

In FIG. 12, (a) shows a LSV profile before and after an accelerated degradation test (ADT) of 30000 cycles of each of commercially available RuO₂ supported on carbon black, Example 6, and Comparative Example 1 which was coated on a nickel foam, and (b) is a drawing showing XRD patterns before and after ADT of each of commercially available RuO₂ supported on carbon black, Example 6, and Comparative Example 1 which was coated on a nickel foam.

(a), (b), and (c) of FIG. 13 are drawings illustrating changes in electrochemical reaction cells before and after ADT of Example 6 coated on a nickel foam, commercially available RuO₂ supported on carbon black coated on a nickel foam, and Comparative Example 1.

In FIG. 14, (a) and (b) are drawings showing C is and Ru 3p peaks measured before and after 30000 cycles of ADT, of commercially available RuO₂ supported on carbon black which was coated on a nickel foam, respectively, in X-ray photoelectron spectroscopy analysis, and (c), (d), (e), and (f) are drawing showing C 1s, Fe 2p, Ni 2p, and O 1s peaks measured before and after 30000 cycles of ADT, of Comparative Example 1 supported on carbon black which was coated on a nickel foam, respectively, in X-ray photoelectron spectroscopy analysis.

FIG. 15 is a drawing illustrating the results of chronoamperometry which proceeded by measuring an overpotential at a point of 50 mA/cm² for 20 hours for commercially available RuO₂ supported on carbon black coated on a nickel foam and Example 6 coated on nickel foam.

FIG. 16 schematically shows a catalyst for oxygen evolution reaction according to an exemplary embodiment of the present invention.

### BEST MODE

Hereinafter, the composite of the present invention will be described in detail with reference to accompanying drawings. The drawings to be provided below are provided by way of example so that the spirit of the present invention can be sufficiently transferred to a person skilled in the art to which the present invention pertains. Therefore, the present invention is not limited to the drawings provided below but may be embodied in many different forms, and the drawings suggested below may be exaggerated in order to clarify the spirit of the present invention. Technical terms and scientific terms used herein have the general meaning understood by those skilled in the art to which the present invention pertains unless otherwise defined, and a description for the known function and configuration which may unnecessarily obscure the gist of the present invention will be omitted in the following description and the accompanying drawings.

In addition, the singular form used in the specification and claims appended thereto may be intended to include a plural form also, unless otherwise indicated in the context.

In the present specification and the appended claims, the terms such as “comprise” or “have” mean that there is a characteristic or a constitutional element described in the specification, and as long as it is not particularly limited, a possibility of adding one or more other characteristics or constitutional elements is not excluded in advance.

In the description of the present invention, a titanium oxide refers to TiO₂₋ₓ (x is a real number of 0.1≤x<2). As a specific example, x may satisfy 0.1 to 1.9, 0.2 to 1.8, 0.3 to 1.7, 0.4 to 1.6, 0.5 to 1.5, 0.6 to 1.4, 0.7 to 1.3, 0.8 to 1.2, 0.9 to 1.1, or 1.

The porous catalyst for oxygen evolution reaction (OER) according to an embodiment of the present invention includes: a porous titanium oxide support satisfying TiO₂₋ₓ (0.1≤x<2); and a metal hydroxide supported on a titanium oxide support.

The catalyst for oxygen evolution reaction (OER) according to the present invention includes a porous titanium oxide support satisfying TiO₂₋ₓ (0.1≤x<2) and a metal hydroxide supported on the titanium oxide support, thereby having significantly improved durability as compared with a catalyst for oxygen evolution reaction of a carbon-based support, having a large specific surface area, and improving mobility of charge carriers from the improved electrical conductivity properties of the titanium oxide support to have excellent OER catalytic performance.

Hereinafter, the catalyst for oxygen evolution reaction provided in an aspect of the present invention will be described in detail for each constituent.

First, the catalyst for oxygen evolution reaction provided in an aspect of the present invention includes a porous titanium oxide support.

As an example, the titanium oxide support may provide excellent stability in an oxygen evolution reaction as compared with a carbon-based support. The oxygen evolution by water electrolysis may theoretically occur at a potential of 1.23 V, but the water electrolysis hardly occurs in practice due to a very slow reaction rate. Therefore, in order to produce oxygen by the water electrolysis in practice, an overpotential of 1.23 V or more is needed. However, carbon corrosion may occur at a significantly low potential range of 0.2 to 0.5 V, and a catalyst for oxygen evolution reaction including a carbon-based support is thermodynamically unstable and increases corrosion due to an oxidation reaction of carbon in an oxygen evolution reaction performed in a potential range of 1.23 V or more, resulting in serious deterioration of catalytic performance and durability of the catalyst for oxygen evolution reaction of the carbon-based support. However, the catalyst for oxygen evolution reaction of the present invention including the titanium oxide support has excellent durability, and thus, has an advantage of stably providing catalytic performance for an oxygen evolution reaction without deterioration of catalytic performance.

The titanium oxide is represented by TiO₂₋ₓ, wherein x may satisfy 0.1 or more and less than 2, 0.1 to 1.9, 0.2 to 1.8, 0.3 to 1.7, 0.4 to 1.6, 0.5 to 1.5, 0.6 to 1.4, 0.7 to 1.3, 0.8 to 1.2, 0.9 to 1.1, or 1. Specifically, in the titanium oxide, x may satisfy 0.7 to 1.3, 0.8 to 1.2, 0.9 to 1.1, or 1, and in this case, smooth charge transfer is allowed by excellent electrical conductivity and reduced band gap energy, and thus, when the titanium oxide is used as a support of the catalyst for oxygen evolution reaction, it may show improved performance characteristics of the catalyst for oxygen evolution reaction.

In an exemplary embodiment of the present invention, an electrical conductivity of the titanium oxide support at a pressure of 20 MPa may be 2 to 10 S/cm, specifically 3 to 8 S/cm, and more specifically 4 to 6 S/cm. Anatase phase titanium dioxide (a-TiO₂) shows electrical conductivity properties at a pressure of 20 MPa of 1 S/cm or less, and the low electrical conductivity properties as such cause a disadvantage of unfree charge movement. Therefore, it is preferred that the titanium oxide support has the electrical conductivity in the above range, in terms of being included as the support of a catalyst for oxygen evolution reaction and allowing movement of charge carriers produced during the oxygen evolution reaction.

As a specific example of the present invention, the titanium oxide may be a cubic crystal phase. The cubic crystal phase titanium oxide is represented by TiO₂₋ₓ, wherein x may satisfy 0.7 to 1.3, 0.8 to 1.2, 0.9 to 1.1, or 1. The cubic crystal phase titanium oxide may have improved electrical conductivity properties as compared with anatase phase titanium dioxide (a-TiO₂), and as an example, the band gap energy of a cubic phase titanium oxide represented by TiO₂₋ₓ wherein x satisfies the above range may be 1.0 to 2.5 eV, specifically 1.3 to 2.0 eV, and more specifically 1.5 to 1.8 eV. Herein, the band gap energy may be a value obtained by a UV-diffuse reflectance spectroscopy (UV-DRS)-based Tauc plot.

It is shown that the cubic crystal phase titanium oxide according to a specific example of the present invention may have a band gap energy lower than the band gap energy of the anatase phase titanium (a-TiO₂)dioxide of 3.0 to 3.5 eV. Having lower band gap energy means more easy movement of charge carriers, which may improve electrical conductivity.

According to an exemplary embodiment of the present invention, the titanium oxide may be a porous titanium oxide including pores.

In an exemplary embodiment of the present invention, the porous titanium oxide may include pores of a volume of 0.1 to 0.2 cm³/g, specifically 0.01 to 0.1 cm³/g, and more specifically 0.01 to 0.05 cm³/g.

In a specific example, the pore size may be 0.1 nm to 1000 nm, specifically 0.5 nm to 500 nm, more specifically 0.5 nm to 300 nm, still more specifically 1 to 100 nm, and still more specifically 1 to 50 nm, but is not necessarily limited thereto. Herein, the pores include open pores, of course.

In an exemplary embodiment, the porous titanium oxide may include micropores and mesopores. According to the definition of International Union of Pure and Applied Chemistry (IUPAC), micropores are pores having a size of 2 nm or less and mesopores are pores having a size of 2 to 50 nm. A volume ratio of micropores:mesopores included in the porous titanium oxide may be 1:2 to 100, specifically 1:2 to 50, and more specifically 1:2 to 10.

The titanium oxide may have a BET specific surface area of 1 to 100 m²/g, 5 to 80 m²/g, 5 to 50 m²/g, 5 to 30 m²/g, 10 to 40 m²/g, or 10 to 20 m²/g, by the porosity described above. The specific surface area properties as such are favorable for metal hydroxide growth in the process of supporting a metal hydroxide on the titanium oxide support described later, and also, may affect the BET specific surface area and the adsorption capacity of the catalyst for oxygen evolution reaction to provide more activation sites, which is preferred for the performance of electrochemical catalyst for oxygen evolution reaction.

Next, the catalyst for oxygen evolution reaction according to an exemplary embodiment of the present invention includes a metal hydroxide supported on the titanium oxide support.

In an exemplary embodiment of the present invention, the metal hydroxide is plate-shaped and is in the form of being loaded on the titanium oxide support.

Herein, the plate shape may refer to a two-dimensional structure including a nanosheet, and the two-dimensional structure may include one or more shapes selected from circular, honeycomb, triangular, elliptical, rhombic, and polygonal shapes, but is not limited thereto.

As an example, the size of the plate shape may be 10 to 1000 nm, specifically 20 to 800 nm, and more specifically 50 to 500 nm.

In a specific example, a metal (2) hydroxide may be in the form in which a single and/or one or more overlapping plate-shaped two-dimensional structures is/are loaded on the titanium oxide support. Herein, regarding the method of producing a catalyst for oxygen evolution reaction to be described later, a plate-shaped metal (2) hydroxide may be produced by a hydration reaction of the metal (1) oxide and an ion exchange reaction between metals, from a metal (1) oxide formed by oxidizing a metal (1) used as a reducing agent produced inside the titanium oxide support, and then the metal (2) hydroxide is bound to the titanium oxide support in an internally grown form through pore channels of the titanium oxide support and grows in a plate shape, which refers to the loaded form. The process by which the metal (2) hydroxide takes the form of being loaded on the titanium oxide support will be described in more detail in the method of preparing a catalyst for oxygen evolution reaction as another aspect of the present invention.

As an example, a conventional catalyst supported on a support is physically and/or chemically bound to the support, so that a weak bond is formed between the support and the catalyst, but the catalyst for oxygen evolution reaction of the present invention is bound to the inside of the titanium oxide support to have a grown catalyst form, thereby providing a catalyst for oxygen evolution reaction having a significantly improved binding force.

As an example, the plate-shaped metal hydroxide which has been bound and grown from the titanium oxide support may have a loaded form in one or more directions selected from a horizontal direction, a vertical direction, and a possible direction between the vertical direction and the horizontal direction to the surface of the titanium oxide support, based on the pore surface of the pores formed in the titanium oxide support.

As an example, a plate-shaped metal hydroxide loaded on the titanium oxide support may be an irregularly aggregated aggregate. It may have specific surface area properties improved by 0.1 to 5 times, specifically 0.5 to 2 times as compared with the BET surface area of the porous titanium oxide described above, by maintaining the plate shape and having an irregularly aggregated form to have the effect of having increased roughness of the surface. Since more active sites may be provided, it is preferred for the performance of the catalyst for oxygen evolution reaction.

In an exemplary embodiment of the present invention, the metal hydroxide may be a hydroxide of a divalent metal.

As an example, the divalent metal may be one or more selected from Ca, Mg, Ni, Mo, Ru, Ir, Mn, Zn, Fe, Co, and Cu.

Though the catalyst for oxygen evolution reaction according to an exemplary embodiment of the present invention does not include precious metal in the divalent metal, it may have catalytic performance equivalent to or higher than the conventional catalyst in the oxygen evolution reaction, and a precious metal may be included in the catalyst for oxygen evolution reaction, but it is preferred to use a significantly small amount as compared with the conventional catalyst in terms of economic feasibility. As described above, any metal included in the metal hydroxide is satisfactory as long as it has a difference in solubility product (Kₛₚ) which causes a spontaneous ion exchange reaction with a metal used as a reducing agent and is a metal having an oxygen evolution reaction activity, and thus, the metal is not limited as long as it is a divalent metal satisfying the above conditions. Herein, the solubility product refers to an equilibrium constant value when a solid salt is dissolved in a solution and is divided into ions.

In an exemplary embodiment of the present invention, the metal contained in the metal hydroxide may include a divalent metal and a trivalent metal.

In an exemplary embodiment, the divalent metal may include one or more selected from Ca, Mg, Ni, Mo, Ru, Ir, Mn, Zn, Fe, Co, and Cu, and the trivalent metal may include one or more selected from Fe, Mo, Cr, Co, Mn, Al, and Ga, but is not limited thereto.

Specifically, the divalent metal may be Ni, and the trivalent metal may be Fe.

According to an exemplary embodiment of the present invention, the metal hydroxide containing the divalent metal and the trivalent metal may be a metal layered double hydroxide (LDH) composite.

The metal layered double hydroxide composite is a metal hydroxide having a laminated planar structure and may be represented by the following Formula 1:

[M²⁺_{(1-x)M}³⁺ₓ(OH)₂][Aⁿ⁻]_{x/n}·mH₂O (Formula 1)

wherein M²⁺ is a cation of a divalent metal, M³⁺ is a cation of a trivalent metal, A Aⁿ⁻ is an anion selected from NO₃⁻, CO₃², PO₄³, Cl⁻, SO₄²⁻, HPO₄²⁻, and combinations thereof, x is a number more than 0 and less than 1, and m is a positive value more than 0.

The metal layered double hydroxide composite has an advantage in which a divalent metal and a trivalent metal may be introduced and dispersed between hydroxide layers without forming clusters, so that catalytic performance may be improved by high dispersity of a metal component having oxygen evolution reaction activity.

In an exemplary embodiment of the present invention, the catalyst for oxygen evolution reaction of the present invention may contain 5 to 60 atom %, preferably 7 to 30 atom %, and more preferably 9 to 15 atom % of the divalent metal and the trivalent metal. For economical and excellent catalytic performance as a catalyst for oxygen evolution, it is preferred to contain the divalent metal and the trivalent metal in the above range.

In a specific example, an atomic ratio of the divalent metal:the trivalent metal contained in the catalyst for oxygen evolution reaction of the present invention may be 1:0.01 to 1, specifically 1:0.01 to 0.5, and more specifically 1:0.01 to 0.1.

When the atomic ratio of the trivalent metal is higher than the above range, the charge quantity of cations is increased too much, so that a stable lamination structure may not be achieved, and when the atomic ratio of the trivalent metal is lower than the ratio in the above range, it is difficult to be present as a single phase metal layered double hydroxide, and thus, it is preferred that the atomic ratio of the divalent metal:the trivalent metal is in the above range.

In an exemplary embodiment, the porous catalyst for oxygen evolution reaction of the present invention may have a BET specific surface area of 1 to 100 m²/g, 5 to 80 m²/g, 5 to 50 m²/g, 5 to 30 m²/g, 10 to 40 m²/g, or 10 to 20 m²/g. As described above, the pore characteristics of the catalyst for oxygen evolution reaction may be affected by the pore characteristics of the titanium oxide support due to the characteristics of the method of producing a catalyst for oxygen evolution reaction which is another aspect of the present invention described later, and it is preferred to have the BET specific surface area in the above range for the performance of the catalyst for an excellent electrochemical oxygen evolution reaction.

In an exemplary embodiment of the present invention, the catalyst for oxygen evolution reaction of the present invention may maintain catalytic performance of 80% or more, specifically 90% or more, more specifically 95% or more, and still more specifically 98% or more for 100 hours after accelerated degradation test (ADT).

Specifically, the accelerated degradation test may be performed by performing chronoamperometry for 100 hours. Herein, when a high value of potential which may derive an electrochemical reaction is applied to an electrode in equilibrium as a step, a current flow is observed, and as such, the chronoamperometry is observation of a current signal depending on time for the applied potential step.

The catalytic performance after an accelerated degradation test according to an exemplary embodiment of the present invention may be performance measured by comparing a change in current density value observed for 100 hours after scanning for 30000 cycles at a scan rate of 100 mV/s in a potential range of 1.0 to 1.6 V_{RHE} with an initially observed current density value.

Herein, the initial current density value as a standard may be a current density value at a point of 10 mA/cm².

Specifically, the accelerated degradation test may be performed by a three-electrode system in a 1.0 M KOH electrolyte, and the three-electrode system may be composed of a Pt wire as a counter electrode (CE), Ag/AgCl as a reference electrode (RE), and a nickel foam electrode (NF) coated with a catalyst ink as a working electrode (WE). Herein, the catalyst ink may be prepared by mixing 5 mg of a catalyst with 0.75 ml of H₂O, 0.25 ml of 2-propanol, and 50 μl of a Nafion solution, sonicating the mixture, and the working electrode may be manufactured by coating the NF with the prepared catalyst ink and then drying in an oven, but the present invention is not limited thereto.

In an exemplary embodiment, the catalyst for oxygen evolution reaction may have catalytic performance after an accelerated degradation test (ADT) of 80% or more, substantially 85% or more, more substantially 90% or more, and still more substantially 93% or more, and as a non-limiting example, 99% or less for 20 hours or more at a potential at which a high current density based on 50 mA/cm² is applied.

The method of preparing a catalyst for oxygen evolution reaction as another aspect of the present invention includes: (a) preparing a composite formed of a porous titanium oxide support satisfying TiO₂₋ₓ (0.1≤x<2) and a metal (1) oxide in which a metal (1) is oxidized by a thermal reduction method from a mixture of anatase phase titanium dioxide (a-TiO₂) and the metal (1) as a reducing agent; (b) reacting the composite with an aqueous solution including an ion of a metal (2) having oxygen evolution reaction activity to prepare a metal (2) hydroxide supported on the titanium oxide support which is reduced by a hydration reaction of the metal (1) oxide and an ion exchange reaction between metals.

The present invention as another aspect provides a method of preparing a catalyst for oxygen evolution reaction including a metal (2) hydroxide supported on a titanium oxide support which is reduced by a hydration reaction of a metal (1) oxide and an ion exchange reaction between metals, by preparing a composite formed of a porous titanium oxide support satisfying TiO₂₋ₓ (0.1≤x<2) and the metal (1) oxide in which a metal (1) as a reducing agent is oxidized, which is reduced by heat treating a mixture of anatase phase titanium dioxide (a-TiO₂) and the metal (1) as a reducing agent, and then reacting the composite with an aqueous solution including the ion of the metal (2) having an oxygen evolution reaction activity.

Conventionally, in preparing a catalyst for oxygen evolution reaction, a process of surface-treating a catalyst support for supporting a catalyst on a catalyst support should be included, but the method of preparing a catalyst for oxygen evolution reaction according to the present invention may reduce a conventional preparation process by providing a process of directly supporting a catalyst on a catalyst support in an aqueous solution by a hydration reaction of the metal (1) oxide in which the metal (1) as a reducing agent is oxidized and an ion exchange reaction between metals, and though conventionally, a catalyst and a catalyst support are physically and/or chemically bound by a surface treatment of the catalyst support, the catalyst for oxygen evolution reaction of the present invention is prepared by exchanging the ion of the metal (1) used as a reducing agent and the ion of the metal (2) having an oxygen evolution reaction activity in a composite formed of a porous titanium oxide support in a stable state and a metal (1) oxide in which the metal (1) as a reducing agent is oxidized, and thus, may provide a significantly better binding force between a catalyst and a catalyst support than before and provide a structurally stable catalyst for oxygen evolution reaction.

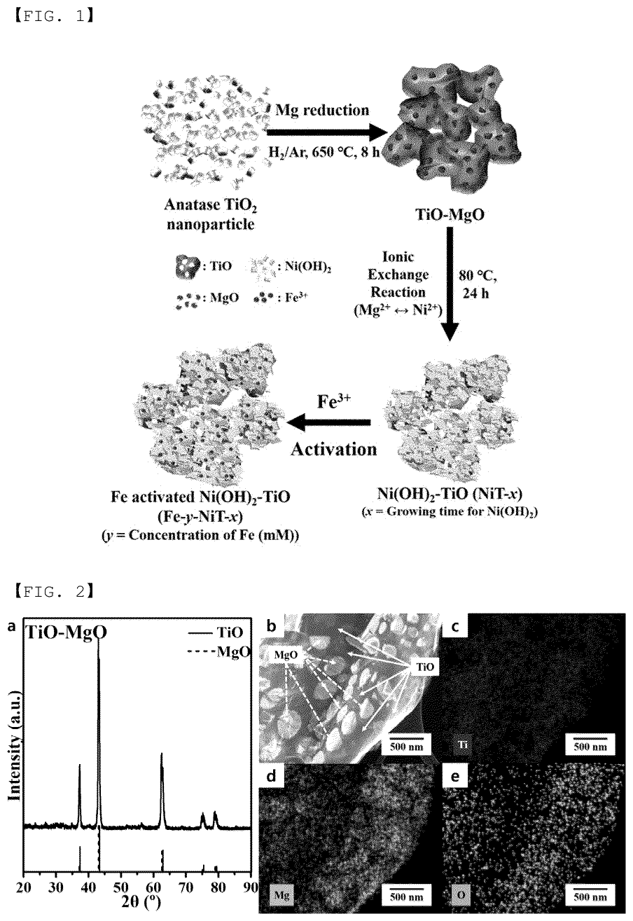

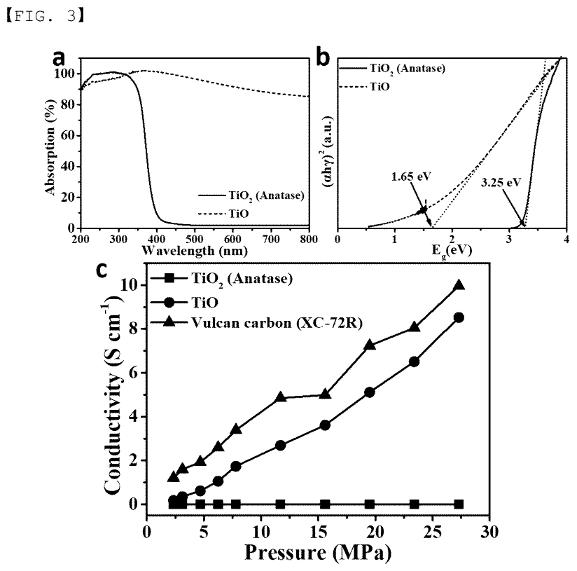

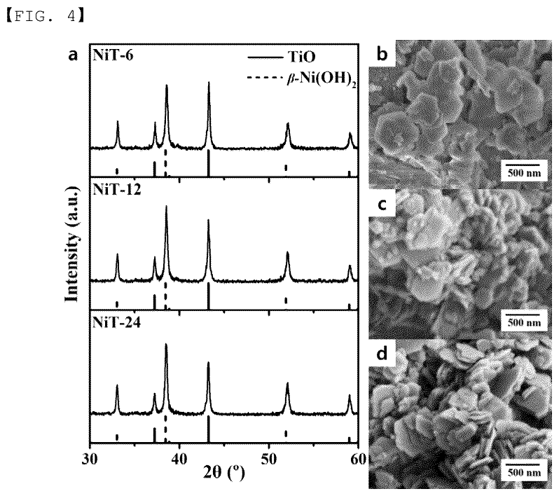

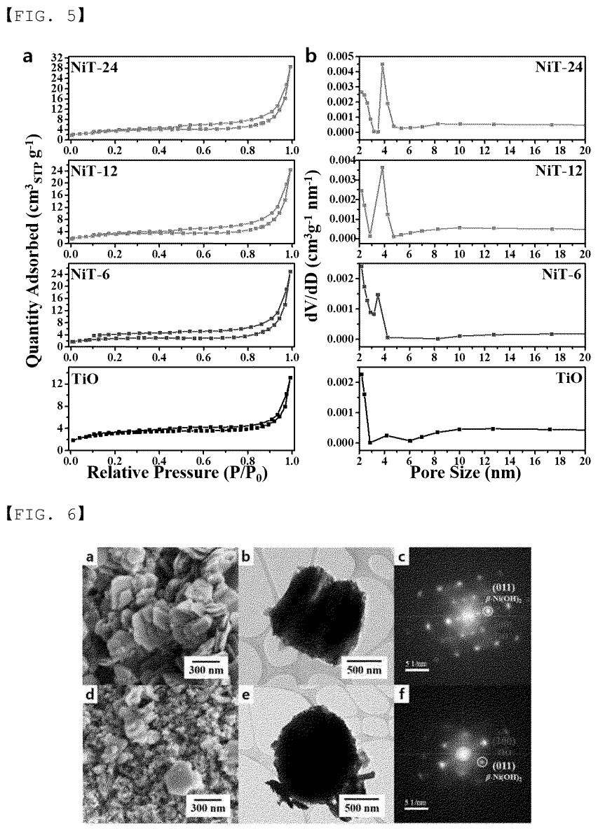

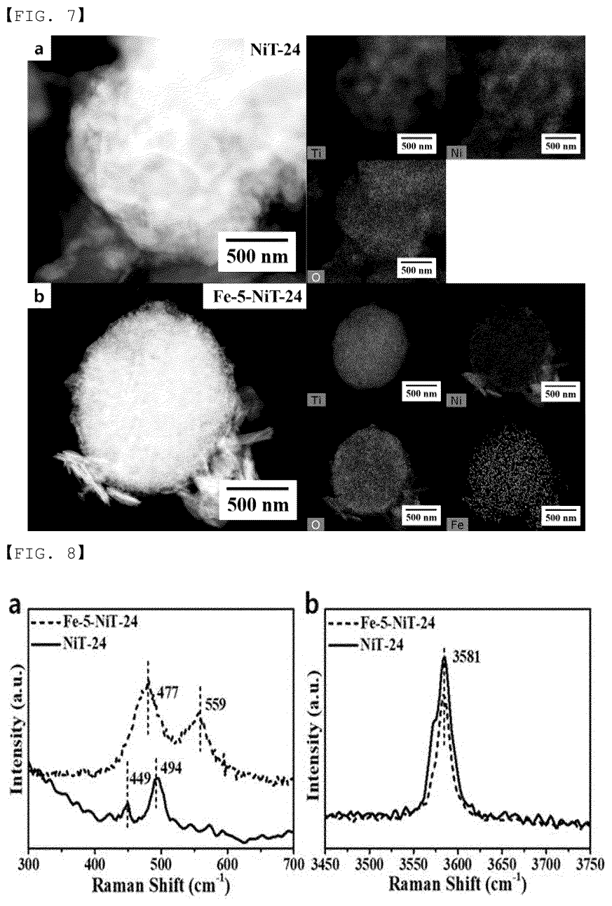

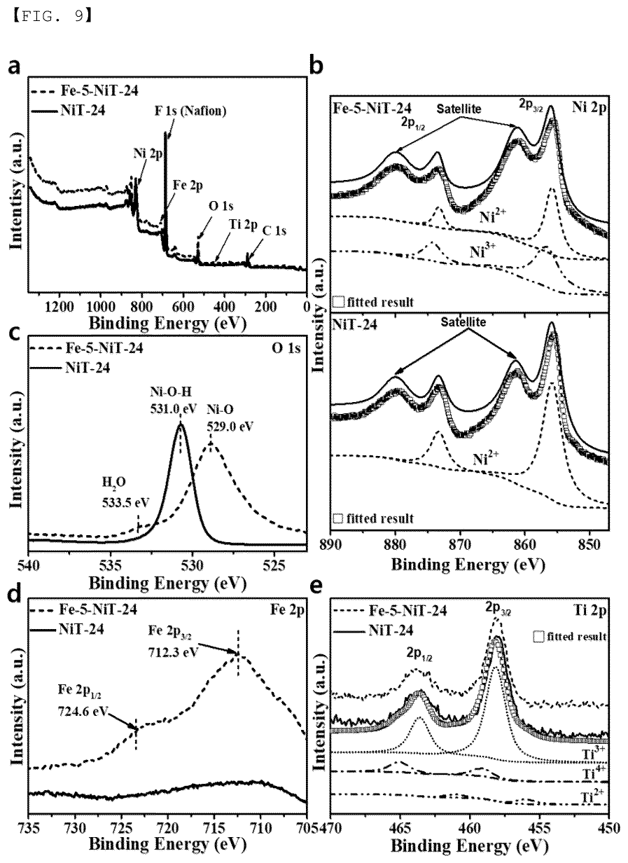

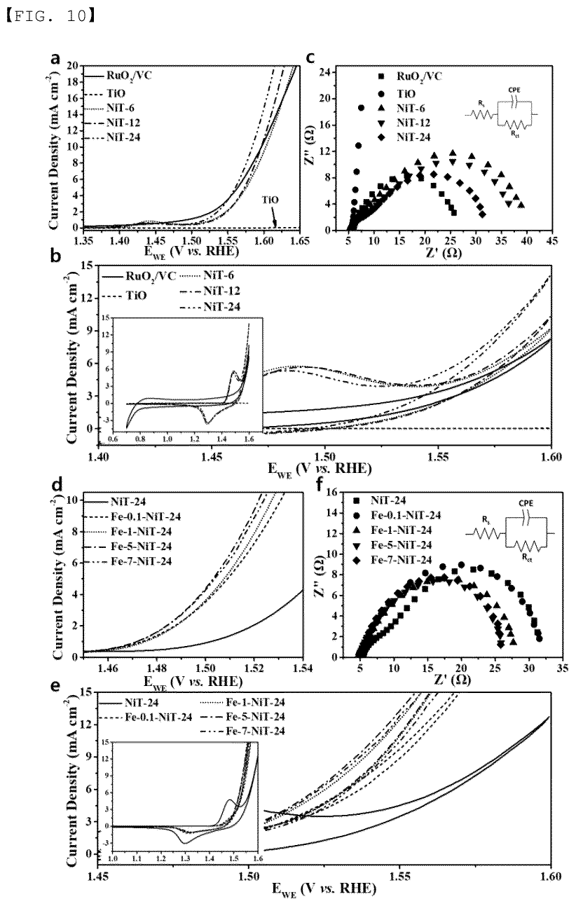

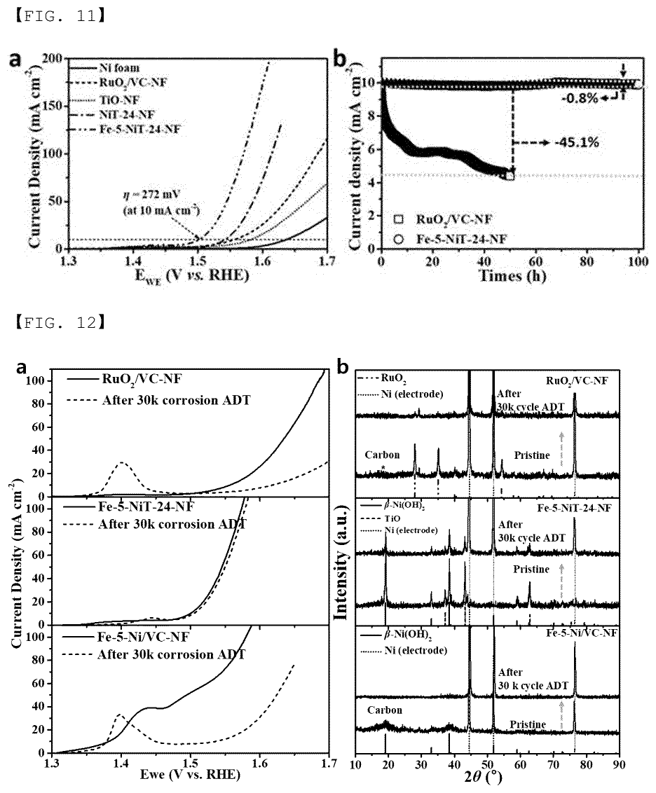

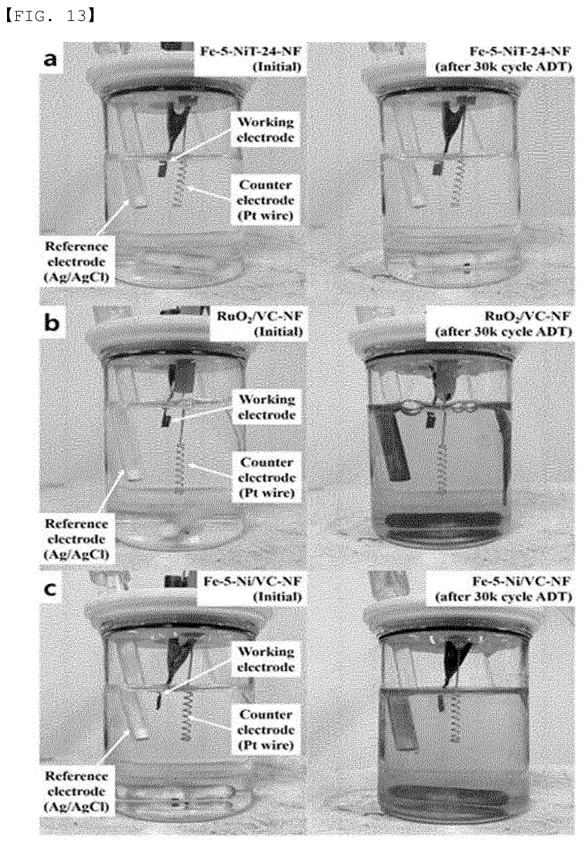

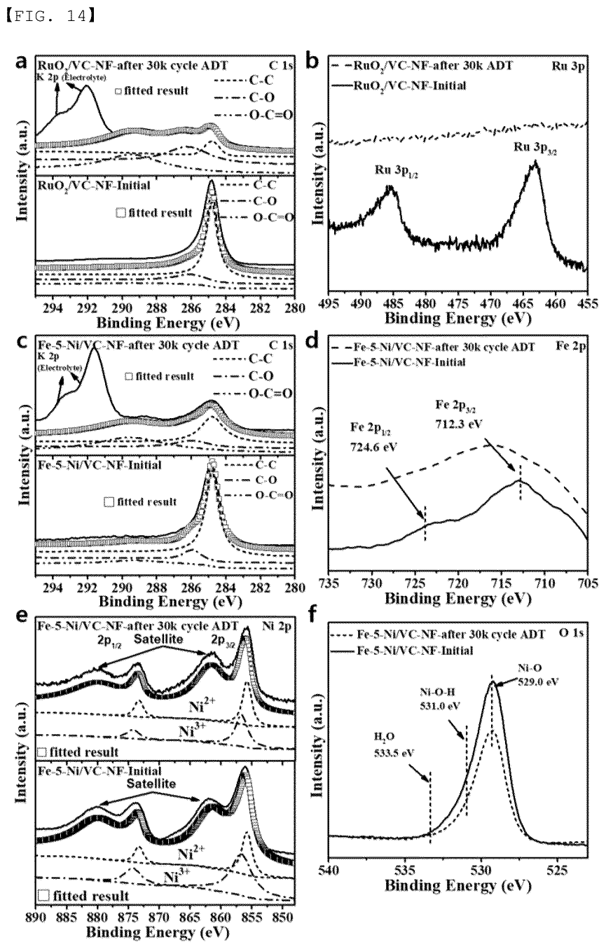

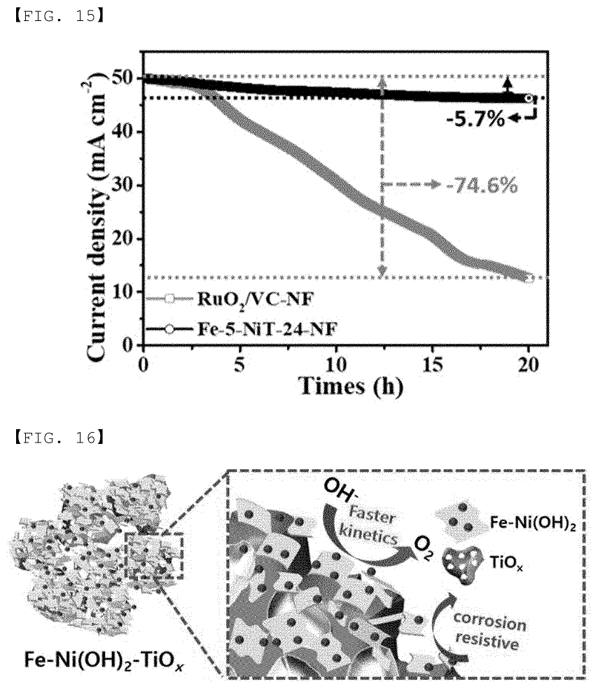

The process of preparing a catalyst for oxygen evolution reaction according to an exemplary embodiment is schematically illustrated in FIG. 1. Hereinafter, the method of preparing a catalyst for oxygen evolution reaction provided in another aspect of the present invention will be described in detail for each step.

The method of preparing a catalyst for oxygen evolution reaction provided in another aspect of the present invention may include: (a) preparing a composite formed of a porous titanium oxide support satisfying TiO₂₋ₓ (0.1≤x<2) and a metal (1) oxide in which a metal (1) as a reducing agent is oxidized by a thermal reduction method from a mixture of anatase phase titanium dioxide (a-TiO₂) and a metal (1) as a reducing agent.

Specifically, a mixed mole ratio of the anatase phase titanium dioxide (a-TiO₂):the metal (1) as a reducing agent may be 1:0.1 to 2, preferably 1:0.5 to 1.5. The mole ratio in the above range is preferred since the porous titanium oxide support described later may be reduced into a form satisfying TiO₂₋ₓ (0.1≤x<2).

As an example, the titanium oxide is represented by TiO₂₋ₓ, wherein x may satisfy 0.1 or more and less than 2, 0.1 to 1.9, 0.2 to 1.8, 0.3 to 1.7, 0.4 to 1.6, 0.5 to 1.5, 0.6 to 1.4, 0.7 to 1.3, 0.8 to 1.2, 0.9 to 1.1, or 1.

As a specific example, the titanium oxide support may satisfy cubic crystal phase TiO₂₋ₓ (0.7≤x≤1.3). As described above, since the cubic crystal phase titanium oxide support satisfying TiO₂₋ₓ (0.7≤x≤1.3)may have a lower band gap energy than that of the anatase phase titanium dioxide (a-TiO₂) and may provide excellent electrical conductivity properties, it is preferred to mix the anatase phase titanium dioxide (a-TiO₂) and the metal as a reducing agent at the above mole ratio.

As a specific example, the mixed anatase phase titanium dioxide (a-TiO₂) may be in a nanopowder form. A diameter of the nanopowder may be 1 to 100 nm, specifically 1 to 50 nm, and more specifically 1 to 30 nm, but is not limited thereto.

As a specific example, the metal (1) as a reducing agent may be one or more selected from the group consisting of Mg, Al, Mn, Ca, Sn, Zn, Sb, Ag, Cu, Ni, Fe, Co, and Si, but any metal is satisfactory as long as it is a metal commonly used as a reducing agent of a metal oxide, and thus, is not limited thereto.

As an example, the metal (1) as a reducing agent may be in a metal powder form.

According to an exemplary embodiment of the present invention, the thermal reduction method may be performed at 300 to 1500° C., but is not limited thereto. For example, the thermal reduction method may be performed at 300 to 1500° C., 600 to 1300° C., or 700 to 1000° C. When the thermal reduction method is performed at lower than 300° C., the anatase phase titanium dioxide (a-TiO₂) may not be reduced well, and when the thermal reduction method is performed at higher than 500° C., the reduction proceeds too much, so that it is difficult to efficiently and systemically control the surface properties of the reduced titanium oxide support and unnecessary energy may be wasted, and thus, it is preferred to perform the thermal reduction method in the above temperature range.

Specifically, the temperature at which the thermal reduction method is performed may be selected depending on a melting point of the metal (1) as a reducing agent. When the thermal reduction method is performed at a temperature near the melting point of the metal (1) as a reducing agent, anatase phase titanium dioxide (a-TiO₂) nanopowder may be fused by the metal (1) as a reducing agent, and the oxide of the meal (1) as a reducing agent may be grown (intergrown) inside the reduced titanium oxide. This becomes a basis for the metal (2) hydroxide described later to be stably supported on the reduced titanium oxide support, it is preferred to perform the thermal reduction method at a temperature near the melting point of the metal (1) as a reducing agent.

In an exemplary embodiment of the present invention, the thermal reduction method may be performed in a reducing gas atmosphere for 3 to 15 hours, specifically 5 to 12 hours, and more specifically 6 to 10 hours, but any duration is satisfactory as long as the anatase phase titanium dioxide (a-TiO₂) is sufficiently reduced to prepare a composite composed of a porous titanium oxide support satisfying TiO₂₋ₓ (0.1≤x<2) and a metal (1) oxide in which a metal (1) as a reducing agent is oxidized, and thus, is not limited thereto.

The reducing gas atmosphere may be formed by a reducing gas, and the reducing gas may assist the reduction of the anatase phase titanium dioxide (a-TiO₂) into the porous titanium oxide satisfying TiO₂₋ₓ (0.1≤x<2).

As an example, the reducing gas may be a hydrogen gas, a hydrocarbon gas, and the like, but is not limited thereto. In addition, it may be used in a state of being mixed with inert gas such as helium, argon, neon, and nitrogen, in which the inert gas may serve as a carrier.

As a specific example, the reducing gas may be a mixed gas of H₂/Ar or H₂/N₂, in which hydrogen may be included at 1 to 10 vol %, specifically 3 to 7 vol %. For preparing the composite formed of the porous titanium oxide support and the metal (1) oxide in which the metal (1) as a reducing agent is oxidized, it is preferred to include hydrogen in the above range in the mixed gas.

The pressure of the reducing gas is not particularly limited, but may be maintained at 0.001 to 10 atm, specifically 0.01 to 1 atm.

According to an exemplary embodiment of the present invention, the composite formed of the porous titanium oxide support satisfying TiO₂₋ₓ (0.1≤x<2) and the metal (1) oxide in which the metal (1) as a reducing agent is oxidized may be prepared.

Specifically, the metal (1) as a melted reducing agent is oxidized to produce the metal (1) oxide, simultaneously anatase phase titanium dioxide (a-TiO₂) in a nanopowder form is reduced, and the reduced titanium oxide is fused with the metal (1) as a melted reducing agent and aggregated, thereby forming the porous titanium oxide support. That is, the metal (1) oxide in which the metal (1) as a reducing agent is oxidized is produced and grows inside the reduced titanium oxide, and as shown in (b) of FIG. 2, the composite may be in a form of being loaded in and bound to the reduced titanium oxide support.

As an example, the size of the metal (1) oxide may be 1 to 1000 nm, specifically 5 to 800 nm, and more specifically 10 to 500 nm.

The method of preparing a catalyst for oxygen evolution reaction provided in another aspect of the present invention may include: (b) reacting the composite with an aqueous solution including an ion of a metal (2) having an oxygen evolution reaction activity to prepare a metal (2) hydroxide supported on the titanium oxide support which is reduced by a hydration reaction of the metal (1) oxide in which the metal (1) as a reducing agent is oxidized and an ion exchange reaction between metals.

Herein, the ion of the metal (2) may be an ion of a divalent metal, and the ion of the divalent metal may include one or more metal cations selected from Ca²⁺, Mg²⁺, Mo²⁺, Ru²⁺, Ir²⁺, Ni²⁺, Mn²⁺, Zn²⁺, Fe²⁺, Co²⁺, and Cu²⁺.

In an exemplary embodiment of the present invention, the composite may be reacted with an aqueous solution including the ion of the metal (2) having an oxygen evolution reaction activity.

In an exemplary embodiment, the concentration of the metal ion contained in the aqueous solution including the ion of the metal (2) having the oxygen evolution reaction activity may be 0.001 to 1 M, specifically 0.01 to 0.5 M, and more specifically 0.05 to 0.2 M. In order for the ion of the metal (2) having the oxygen evolution reaction activity to react with the composite to produce the metal (2) hydroxide, it is preferred to include the aqueous solution including the ion of the metal (2) having the oxygen evolution reaction activity satisfying the concentration in the above range.

Specifically, the reaction with the aqueous solution including the composite and the ion of the metal (2) having the oxygen evolution reaction activity may be performed by continuous stirring for 1 to 48 hours, specifically 2 to 36 hours, and more specifically 4 to 26 hours. Since the metal (2) hydroxide is produced, grows into a plate form, and supported on the reduced titanium oxide support described later by the reaction with the aqueous solution including the composite and the ion of the metal (2) having the oxygen evolution reaction activity, it is preferred that the reaction with the aqueous solution including the composite and the ion of the metal (2) having the oxygen evolution reaction activity is performed by continuous stirring for the time in the above range.

As an example, a continuous stirring reaction may be performed at 40 to 100° C., specifically 60 to 80° C., but since the temperature range in which the continuous stirring reaction is performed is for performing the stirring reaction well, it is not limited thereto.

In an exemplary embodiment of the present invention, the metal (2) hydroxide supported on the titanium oxide support which is reduced by the continuous stirring reaction with the aqueous solution including the composite and the ion of the metal (2) having the oxygen evolution reaction activity described above may be prepared.

Herein, the metal (2) hydroxide may be a metal (2) hydroxide including the ion of the metal (2) having the oxygen evolution reaction activity.

As a specific example of the present invention, a hydration reaction of the metal (1) oxide in which the metal (1) as a reducing agent is oxidized and an ion exchange reaction between metals may occur by the continuous stirring reaction described above.

Specifically, the continuous stirring reaction is performed in an aqueous solution including the ion of the metal (2) having an oxygen evolution reaction activity, and the metal (1) oxide in which the metal (1) as a reducing agent is oxidized reacts with water in an aqueous solution by a hydration reaction to produce a first metal hydroxide including the metal (1) as a reducing agent. Again, the first metal hydroxide including the metal (1) as a reducing agent reacts with the ion of the metal (2) having the oxygen evolution reaction activity to finally exchange the ions between metals to produce the metal hydroxide including the metal (2) having the oxygen evolution reaction activity (second metal hydroxide).

As an example, the ion exchange reaction between metals may be a spontaneous reaction. This is due to a difference in a solubility product (Kₛₚ) of the metal hydroxide (second metal hydroxide) including the first metal hydroxide including the metal (1) as a reducing agent and the metal (2) having the oxygen evolution reaction activity, and since the metal hydroxide including the metal (2) having the oxygen evolution reaction activity (second metal hydroxide) has a smaller solubility product value than the first metal hydroxide including the metal (1) as a reducing agent, the ion exchange reaction may occur spontaneously. Herein, the solubility product refers to an equilibrium constant value when a solid salt is dissolved in a solution and is divided into ions.

According to an exemplary embodiment of the present invention, the metal (2) hydroxide may grow inside through a pore channel of the titanium oxide support.

As described above, the first metal hydroxide including the metal (1) as a reducing agent is produced from the metal (1) oxide in which the metal (1) as a reducing agent is oxidized, in the form of being loaded in and bound to the titanium oxide support and the metal hydroxide (second metal hydroxide) is produced from the spontaneous ion exchange reaction from the first metal hydroxide including the metal (1) as a reducing agent, and thus, the metal hydroxide (second metal hydroxide) produced as such may grow inside through the pore channel of the titanium oxide support. Since the metal hydroxide (second metal hydroxide) is loaded in the titanium oxide support and grows in a bound form, a problem of the metal hydroxide (second metal hydroxide) being peeled off or detached from the support is solved and structurally significantly improved stability may be provided.

As a specific example, the growth degree of the metal (2) hydroxide which grows inside through the pore channel of the titanium oxide support may be controlled by the time of the continuous stirring reaction described above, and the metal (2) hydroxide may grow into a plate shape of the two-dimensional structure. Herein, the time of the continuous stirring reaction may be the same as the time of the ion exchange time. That is, the ion exchange reaction may be performed for 1 to 48 hours, specifically 2 to 36 hours, and more specifically 4 to 26 hours.

As an example, the size of the plate shape may be 10 to 1000 nm, specifically 20 to 800 nm, and more specifically 50 to 500 nm.

In an exemplary embodiment of the present invention, the hydration reaction, the ion exchange reaction, and the growth of the metal (2) hydroxide may proceed in-situ.

Conventionally, a catalyst support and a catalyst should be separately prepared or a process of surface treating a catalyst support for supporting a catalyst on the catalyst support should be included, but since in the method of preparing a catalyst for oxygen evolution reaction according to another aspect of the present invention, the metal (1) oxide supported on the reduced titanium oxide support is prepared by the hydration reaction, the ion exchange reaction, and the growth of the second metal hydroxide and the reaction proceeds in-situ, the conventional preparation process is reduced to prepare the catalyst for oxygen evolution reaction in an economical way and provide the catalyst for oxygen evolution reaction having a significantly stable structure.

In an exemplary embodiment of the present invention, after (b) described above, a step of doping the metal (2) hydroxide supported on the titanium oxide support with a trivalent metal ion may be further included.

As an example, the doping trivalent metal ion may include one or more metal cations selected from Fe³⁺, Cr³⁺, Mo³⁺, Co³⁺, Mn³⁺, Al³⁺, and Ga³⁺.

According to an exemplary embodiment of the present invention, the doping with the trivalent metal ion may be performed by a wetting method, a high-temperature treatment method, an ion implantation method, an electrochemical activation process, and the like, but any doping method is satisfactory as long as the trivalent metal ion is stably doped by the ion doping method known in the art, and thus, the present invention is not limited thereto.

As an example, the trivalent metal ion doped on the metal (2) hydroxide supported on the titanium oxide support may be doped by an electrochemical activation process.

Specifically, the doping with the trivalent metal ion may be performed by a three-electrode system, the metal (2) hydroxide supported on the titanium oxide support may be used as a working electrode, and the trivalent metal ion may be included in an electrolyte used herein. The ion of the trivalent metal may be included at 0.01 to 50 mM, specifically 0.1 to 10 mM in a 1 M electrolyte. In a three-electrode system, any reference electrode and any counter electrode may be satisfactory as long as they are electrodes known in the art, and thus, are not limited thereto.

More specifically, in the doping with the trivalent metal ion performed by the three-electrode system, a bias of 1.34 V_{RHE} may be applied for 1 hour for avoiding interference due to the production of oxygen bubble, and 50 cycles of cyclic voltammetry (CV) may be performed at V_{RHE} between 0.8 and 1.65 at a scan rate of 50 mV s⁻¹ for an electrochemical activation reaction.

In an exemplary embodiment of the present invention, a metal layered double hydroxide (LDH) composite may be supported on the titanium oxide support by the doping with the trivalent metal ion.

As an example, the metal layered double hydroxide composite may contain the ions of the divalent metal and the trivalent metal described above, and since the ions of the divalent metal and the trivalent metal are introduced between hydroxide layers and have high dispersity without forming a cluster, the performance of the catalyst for oxygen evolution reaction may be improved.

Hereinafter, the present invention will be described in more detail by way of the examples and the experimental examples. The scope of the present invention is not limited to the specific examples, and should be construed by the appended scope. In addition, it should be understood by a person skilled in the art that many modifications and variations are possible without departing from the scope of the present disclosure.

### PREPARATION EXAMPLE 1

### Preparation of TiO—MgO Composite

4 g of anatase TiO₂ powder having a diameter of 25 nm or less and 1.21 g of Mg powder were mixed so that a mole ratio was 1:1, and the uniform mixture was added to a quartz tube furnace and heated under a 5 vol % H₂/Ar flow at 650° C. to prepare a TiO—MgO composite.

### PREPARATION EXAMPLE 2

### Preparation of Porous TiO

A TiO—MgO composite was prepared in the same manner as in Preparation Example 1, and the heated sample was stirred with a 2 M diluted hydrochloric acid solution (35 to 37 vol % of distilled water) for 8 hours to selectively etch a MgO phase. As a result, porous reducing TiO having no MgO was obtained.

### Example 1

### In-Situ Synthesis of Ni(OH)₂—TiO Composite (NiT-6)

0.8 g of Preparation Example 1 (TiO—MgO composite) was continuously stirred at 80° C. for 6 hours in 80 ml of 0.1 M Ni(NO₃)₂·6H₂O (98.0%, Samchun) solution. Precipitate after stirring was washed with distilled water, and centrifugation and lyophilization were performed sequentially to produce a Ni(OH)2 form supported on a TiO support, that is, a Ni(OH)₂—TiO as a final product, which was named NiT-6.

### Example 2

### In-Situ Synthesis of Ni(OH)₂—TiO Composite (NiT-12)

The process was performed in the same manner as in Example 1, except that stirring was performed continuously for 12 hours, and the product was named NiT-12.

### Example 3

### In-Situ Synthesis of Ni(OH)₂—TiO Composite (NiT-24)

The process was performed in the same manner as in Example 1, except that stirring was performed continuously for 24 hours, and the product was named NiT-24.

Hereinafter, Examples 1 to 3 were named NiT-x.

### Example 4

### Synthesis of Active Iron (Fe)-0.1-Ni(OH)₂—TiO Composite (Fe-0.1-NiT-24)

Active iron was synthesized in NiT-24 of Example 3 by an electrochemical activation reaction using Fe(NO₃)₃9H₂O in which 0.1 mM F³⁺ was dissolved and a 1.0 M KOH electrolyte. The synthesis was performed by a three-electrode system, and the three-electrode system was composed of a working electrode of Example 3 (NiT-24) coated on a glassy carbon electrode or a Ni foam, a counter electrode which was a Pt wire, a reference electrode which was Ag/AgCl, and a potentiostat. A bias of 1.34 V_{RHE} was applied for 1 hour for avoiding interference due to the production of oxygen bubble, and 50 cycles of cyclic voltammetry (CV) was performed at V_{RHE} between 0.8 and 1.65 at a scan rate of 50 mV s⁻¹ for an electrochemical activation reaction. The composite obtained by synthesizing active iron in NiT-24 of Example 3 through the three-electrode system including a 1.0 M KOH electrolyte in which 0.1 mM Fe³⁺ was dissolved was named Fe-0.1-NiT-24.

### Example 5

### Synthesis of Active Iron (Fe)-1-Ni(OH)₂—TiO Composite (Fe-1-NiT-24)

The preparation was the same as in Example 4, but active iron was synthesized in NiT-24 of Example 3 through a three-electrode system including a 1.0 M KOH electrolyte in which 1 mM Fe³⁺ was dissolved, which was named Fe-1-NiT-24.

### Example 6

### Synthesis of Active Iron (Fe)-5-Ni(OH)₂—TiO Composite (Fe-5-NiT-24)

The preparation was the same as in Example 4, but active iron was synthesized in NiT-24 of Example 3 through a three-electrode system including a 1.0 M KOH electrolyte in which 5 mM Fe³⁺ was dissolved, which was named Fe-5-NiT-24.

### Example 7

### Synthesis of Active Iron (Fe)-7-Ni(OH)₂—TiO Composite (Fe-7-NiT-24)

The preparation was the same as in Example 4, but active iron was synthesized in NiT-24 of Example 3 through a three-electrode system including a 1.0 M KOH electrolyte in which 7 mM Fe³⁺ was dissolved, which was named Fe-7-NiT-24.

### Comparative Example 1

### Synthesis of Active Iron (Fe)-5-Ni(OH₂-VC Composite (Fe-5-Ni/VC)

A support on which active iron (Fe)—Ni(OH)₂ was supported was manufactured with carbon. First, for preparing a Ni(OH)₂—C composite, 91 mg of carbon black (Vulcan carbon; XC-72R) which is a commercial carbon support, 197 mg of Ni(NO₃)₂ 6H₂O, and 500 mg of hexamethyltetramine were dispersed in 500 ml of distilled water for 30 minutes. The mixture was sealed, heated to 95° C., and then maintained in an oven for 6 hours. Thereafter, the produced precipitate was washed with distilled water, and was centrifuged and lyophilized sequentially to obtain a Ni(OH)₂—C composite. Finally, a Ni(OH)₂—C composite was treated in the same manner as in Example 6 to prepare a Fe-5-Ni/VC composite.

### Experimental Example 1

### Confirmation of TiO—MgO Composite Formation

A phase structure of a sample was confirmed by powder X-ray diffraction (XRD, Rigaku Smartlab, 40 kV, 15 mA, 4° min⁻¹, Cu-Kα radiation, λ=0.15406 nm).

As in Preparation Example 1, when a-TiO₂ and Mg were mixed and annealed at 650° C. under H₂/Ar (5 vol % H₂), a a-TiO₂ peak disappeared and a new MgO peak and a reduced TiO peak were confirmed, as seen in the XRD results of (a) of FIG. 2.

In addition, as shown in the scanning transmission electron microscopic (STEM) image of (b) and the energy dispersive X-ray spectroscopy (EDS) electron mapping images of (c), (d), and (e) in FIG. 2, a MgO phase grew inside a TiO framework during a magnesium thermal reduction process.

During annealing at 650° C., Mg (melting point: 650° C.) started to melt and small a-TiO₂ nanoparticles (NP) were fused therewith to grow into large micron-sized particles. A strong reducing agent Mg took oxygen from TiO₂ according to the following Chemical Reaction 1 to form MgO, while deoxygenated a-TiO₂ nanopowders clumped together to be converted into an oxygen-deficient cubic TiO phase having a larger particle size. Though a-TiO₂ is also reduced by H₂ according to the following Chemical Reaction 2 to produce H₂O as well as a TiO phase, the Gibbs free energy of MgO (solid, −596.4 kJmol⁻¹) is much lower than that of H₂O (gas, −228.6 kJmol⁻¹), and thus, formation of MgO was prioritized during the thermal reduction process of magnesium under a H₂/Ar flow.

TiO₂+Mg↔TiO+MgO (Chemical Reaction 1)

TiO₂+H₂↔TiO+H₂O (Chemical Reaction 2)

### Experimental Example 2

### Confirmation of Band Gap and Electrical Conductivity of TiO

Ultraviolet-visible (UV-Vis) absorption spectrum was observed using a CARY5000 UV-Vis spectrophotometer (Agilent Technology).

The UV-Vis absorption spectra of a-TiO₂ and Preparation Example 2 (TiO) showed significantly different absorption properties in a visible light region (400-800 nm) in spite of the similar absorption properties in a UV region (200-400 nm), as seen from (a) of FIG. 3, Preparation Example 2 showed absorption even in wavelengths in a visible light region and an infrared region, unlike a-TiO₂. A band gap value obtained in a Tauc plot based on UV-diffuse reflectance spectroscopy (UV-DRS) was 3.25 eV and 1.65 eV, respectively, for a-TiO₂ and Preparation Example 2 (FIG. 3b). A narrow band gap energy of Preparation Example 2 resulted from phase transformation of pure anatase TiO₂ into a cubic TiO phase and formation of Ti³⁺. The decreased band gap energy helps improvement of electrical conductivity, and a correlation between decreased bend gap energy and electrical conductivity was confirmed by measurement of 4-probe electrical conductivity of an oxide sample ((c) of FIG. 3).

A 4-probe constituent cell manufactured for measuring a change in electrical conductivity in a pressurized state was used, and Keithley model 6220 and model 2182 A were used as a low direct current (DC) source and a voltmeter, respectively.

As shown in (c) of FIG. 3, it was confirmed that Preparation Example 2 (TiO) showed a high electrical conductivity value of 5.17 Scm⁻¹ at 20 MPa as compared with a-TiO₂ (8.8910⁻⁵×Scm⁻¹), and further, an electrical conductivity of a carbon support (Vulcan carbon; XC-72R) which is commercially available as a support of an OER catalyst was compared together. The measured electrical conductivity of Vulcan carbon was 7.12 Scm⁻¹ at 20 MPa, and it was confirmed that Preparation Example 2 (TiO) has high potential as a material to replace a carbon support which is commercially available as a conventional OER catalyst support.

### Experimental Example 3

### Confirmation of Production of Ni(OH)₂—TiO Composite and Pore Characteristics

The composites prepared according to Examples 1 to 3 were characterized by XRD analysis and a field emission scanning microscope (FE-SEM, Hitachi S-4800) operated at 3 kV and 10 μA.

It was confirmed that the XRD pattern shown in (a) of FIG. 4 matched a β-Ni(OH)₂ (JCPDS Card #01-074-2075) peak and a cubic phase TiO (JCPDS Card #03-065-2900) peak, and thus, a Ni(OH)₂—TiO composite was produced.

As shown in (b) of FIG. 4, it was confirmed that a particle form of the produced composite was a plate-shaped Ni(OH)₂ nanosheet, and as shown in (c) and (d) of FIG. 4, as the time of stirring in a 80 ml of 0.1 M Ni(NO₃)₂ 6H₂O solution at a temperature of 80° C. was increased, the plate-shaped nanosheet was further grown to have an aggregated form.

As a result of the XRD pattern and morphology of the Ni(OH)₂—TiO composite synthesized according to the time during which the TiO—MgO composite prepared according to Preparation Example 1 was stirred in a 80 ml of 0.1 M Ni(NO₃)₂ 6H₂O solution at a temperature of 80° C., it was confirmed that Ni(OH)₂ was grown the best in the Ni(OH)₂—TiO composite (Example 3, NiT-24) formed by stirring for 24 hours.

While the TiO—MgO composite prepared according to Preparation Example 1 was stirred in a 80 ml of 0.1 M Ni(NO₃)₂ 6H₂O solution at a temperature of 80° C., MgO grown in TiO was converted into Mg(OH)₂ by a hydration reaction and Mg of the converted Mg(OH)₂ was again ion-exchanged with a Ni²⁺ ion present in an aqueous solution as in the following Chemical Reaction 4 so that Ni(OH₂) grew by the ion exchange reaction. In this case, while MgO was converted into Mg(OH)₂ on the surface of TiO, the Ni(OH)₂ nanosheet grew directly in-situ through pore channels of a TiO support. This was caused by a difference in a solubility product (Kₛₚ), and the ion exchange reaction was a spontaneous reaction due to a difference in a solubility product between Mg(OH)₂ (Kₛₚ=5.61×10⁻¹² at 25° C.) and Ni(OH)₂ (Kₛₚ=5.48×10⁻¹⁶ at 25° C.)/

MgO+H₂O→TiO+Mg(OH)₂ (Chemical Reaction 3)

Mg(OH)₂+Ni²⁺(aq)→Ni(OH)₂+Mg2+(aq) (Chemical Reaction 4)

The pore properties of the Ni(OH)₂—TiO composite and Preparation Example 2 (TiO) of which the production was confirmed by XRD pattern and morphology analysis were confirmed.

A N₂ adsorption-desorption isotherm was obtained using a Brunauer-Emmett-Teller (BET) surface analyzer at a test temperature of 77 K. The BET and Barret-Joyner-Halenda (BJH) analyses were used to determine surface area, pore volume, and pore size distribution. The BET surface area was calculated using an experimental point at a relative pressure of P/P₀=0.05-0.30. The pore size distribution was derived from an adsorption branch using the BJH method. A total pore volume was presumed by an adsorbed amount of N₂ at a relative pressure (P/P₀) of 0.995.

The porous surface properties of preparation Example 2 in which MgO was removed from the TiO—MgO composite, and NiT-6 (Example 1), NiT-12 (Example 2), and NiT-24 (Example 3) synthesized depending on the stirring time were measured (FIG. 5), and the results are summarized in the following Table 1.

The BET surface area and the pore volume of TiO were calculated as 11.14 m²/g and 0.018 cm³/g, respectively, and this phenomenon occurs in a magnesium thermal reduction process in which Mg melted at 650° C. takes oxygen from TiO₂ to form MgO, while a-TiO₂ nanopowder is fused and united with melted MgO, so that deoxygenated a-TiO₂ nanopowders clumped together to form larger aggregated TiO particles. Thus, the surface area was rapidly decreased in the reduced TiO sample including large macropores. However, the Ni(OH)₂nanosheet grew along the pore channels of the TiO support in a plate shape during the process of forming the Ni(OH)₂—TiO composite, and as the stirring time increased, the plate-shaped Ni(OH)₂ nanosheet was aggregated, and since the aggregation form was irregular in a state of maintaining the sheet shape, the surface area tended to increase as the stirring time increased. In particular, it was shown that the NiT-24 composite formed by stirring for 24 hours had high values of BET surface area and pore volume.

The pore properties may improve the catalytic performance by the effect of increased activation site in an OER catalyst reaction.

TABLE 1

| Sample | S_{BET}/ | V_{micro}/ | Vₘ [symbol] / | Vₜₒₜₐₗ/ | |
|---|---|---|---|---|---|
| name | m²g⁻¹ | cm³g⁻¹ | cm³g⁻¹ | cm³g⁻¹ | PSD/nm |
| TiO | 11.14 | 0.004 | 0.018 | 0.022 | 13.48 |
| NiT-6 | 11.28 | 0.004 | 0.036 | 0.041 | 21.46 |
| NiT-12 | 11.48 | 0.004 | 0.037 | 0.045 | 16.18 |
| NiT-24 | 12.73 | 0.006 | 0.044 | 0.050 | 15.38 |

[symbol]

indicates data missing or illegible when filed

### Experimental Example 4

### Confirmation of Production of Active Iron (Fe)—Ni(OH)₂—TiO Composite

Subsequently, active iron was synthesized in NiT-24 by a three-electrode system including NiT-24 prepared in Example 3 and a 1.0 M KOH electrolyte in which a Fe³⁺ ion was dissolved at different concentration to prepare a Fe-y-NiT-24 composite. At this time, y refers to the concentration of the Fe³⁺ ion dissolved in the KOH electrolyte.

The morphology properties of Fe-5-NiT-24 prepared by a three-electrode system including NiT-24 and a 1.0 M KOH electrolyte in which a 5 mM Fe³⁺ ion was dissolved were compared, and the results are shown in FIG. 6. In FIG. 6, (a), (b), and (c) are SEM, HAADF-TEM, and fast Fourier transform (FFT) images of NiT-24, respectively, and (d), (e), and (f) are SEM, HAADF-TEM, and FFT images of Fe-5-NiT-24, respectively.

As shown in (a) and (d) of FIG. 6, a changed particle form was observed, and it was confirmed in the Fe-5-NiT-24 composite that the Ni(OH)₂ nanosheet was wrinkled and decreased as compared with the NiT-24 composite. This was due to Fe³⁺ or K⁺ ions included in the electrolyte for synthesis of NiFe-layered double hydroxide (LDH) being intercalated between the Ni(OH)₂ layers or deintercalated between the Ni(OH)₂ layers. It was confirmed that the synthesized NiFe-LDH was not an amorphous form as confirmed by the FFT pattern of (f) of FIG. 6.

FIG. 7 shows high-angle annular dark field (HAADF)-TEM images of NiT-24 and Fe-5-NiT-24 composites and the energy-dispersive X-ray spectroscopy (EDS) elemental mapping image corresponding thereto.

As shown in (b) of FIG. 7, it was confirmed that Ti, Ni, O, and Fe elements were uniformly dispersed in the Fe-5-NiT-24 composite, and the chemical compositions of the NiT-24 and Fe-5-NiT-24 composite measured from EDS are summarized in the following Table 2.

TABLE 2

| | Fe (at %) | | Ni (at %) | | Ti (at %) | | O (at %) | |
|---|---|---|---|---|---|---|---|---|
| Sample name | TEM-EDS | ICP | TEM-EDS | ICP | TEM-EDS | ICP | TEM-EDS | ICP |
| NiT-24 | — | — | 12.6 | 16.4 | 62.7 | 83.6 | 24.7 | — |
| Fe-5-NiT-24 | 0.5 | 0.1 | 12.7 | 16.5 | 63.7 | 83.4 | 23.1 | — |

As shown in Table 2, it was confirmed in Fe-5-NiT-24 that 0.5 atom % of Fe was successfully synthesized in the NiT-24 composite.

The structural change in the Fe-5-NiT-24 composite in which active Fe was synthesized from the NiT-24 composite was analyzed by Raman spectroscopy (FIG. 8). The surface was analyzed with a Raman spectrometer (Thermo Scientific, NICOLET ALMECA XR) and excited using a laser beam at 532 nm.

As shown in (a) of FIG. 8, the peak of NiT-24 was confirmed at 449 cm⁻¹ and 494 cm⁻¹ in a low Raman shift range of 300 to 700 cm⁻¹, respectively, and was due to the vibration of a Ni—O bond in β-Ni(OH)₂ and a Ni—O bond of defected or disordered Ni(OH)₂. However, it was confirmed that the peak of Fe-5-NiT-24 was shown in 447 cm⁻¹ and 559 cm⁻¹, respectively and it was shown that it was due to the vibration of a Ni—O bond belonging to NiOOH having y-NiOOH and β-NiOOH phases.

(b) of FIG. 8 shows that both NiT-24 and Fe-5-NiT-24 showed strong peaks at 3581 cm⁻¹ in a high Raman shift range in a range of 3400 to 3800 cm⁻¹, which was due to the O—H vibration in β-Ni(OH)₂. However, a little lower peak intensity of Fe-5-NiT-24 than NiT-24 was due to increased disorder of the β-Ni(OH)₂ structure, after Fe activation.

In summary, it was confirmed that NiT-24 had only a β-Ni(OH)₂ phase, while Fe-5-NiT-24 had both β-Ni(OH)₂ and β-NiOOH phases. That is, in the Fe activation step, there was a structural change in which the β-Ni(OH)₂ phase was converted into a mixed phase formed of β-Ni(OH)₂ and β-NiOOH phases.

In addition, X-ray photoelectron spectroscopy (XPS) was performed using an XPS system (ESCALAB 250) having a monochromatic Al Kα (150 W) source for analysis of the chemical state of a sample surface. A fermi level (4.10 eV vs. absolute vacuum value) of an XPS instrument was used to align the energy scale.

FIG. 9 illustrates the XPS spectra of NiT-24 and Fe-5-NiT-24 composites. In the survey spectrum of (a) of FIG. 9, the F 1s peak was found in the NiT-24 and Fe-5-NiT-24 composites, which was due to the Nafion used during the process of preparing the sample.

As shown in (b) of FIG. 9, the main peak of NiT-24 in the Ni 2p spectrum was found in the binding energy of 855.7 and 873.3 eV, which was due to Ni²⁺2p_{3/2} and Ni²⁺2p_{1/2}. The spin-energy separation between the two main peaks was confirmed as 17.6 eV, and this means the presence of Ni(OH)₂. However, it was confirmed that the main peak of Fe-5-NiT-24 was shown in the binding energy of 856.6 and 874.2 eV due to the chemical shift. This was due to the presence of Ni³⁺, and it was shown that this was consistent with the fact that β-NiOOH was present in the Fe-5-NiT-24 composite which was analyzed above by the Raman spectroscopy.

Upon review of the O 1s spectrum, as shown in (c) of FIG. 9, NiT-24 had a single peak of 531.0 eV which was due to the Ni—O—H phase of Ni(OH)₂, and Fe-5-NiT-24 had a dominant peak of 529.0 eV and a peak of 533.5 eV which were due to the Ni—O bond and water molecules absorbed on the surface, respectively. The change in spectrum as such was due to the change of Ni(OH)₂ on the surface of the sample to NiFe-LDH in the Fe activation process. In addition, as shown in (d) of FIG. 9, in the Fe 2p spectrum, no peak was found in NiT-24 and the peaks found at 712.3 and 724.6 eV in Fe-confirmed the presence of Fe³⁺ resulting from NiFe-LDH.

As shown in (e) of FIG. 9, in the Ti 2p spectrum, it was confirmed that both NiT-24 and Fe-5-NiT-24 were formed of Ti²⁺, Ti³⁺, and Ti⁴, and the two deconvoluted main peaks were shown in 458.1 and 463.5 eV corresponding to Ti³⁺2p_{3/2} and Ti³⁺2p_{1/2}, respectively. That is, considering the surface sensitivity detected to the depth of about 10 nm from the surface by XPS, it was found that the TiO surface was formed of a dominant Ti³⁺ species.

### Experimental Example 5

### Evaluation of Electrochemical OER Performance of Each Sample

The OER properties of each sample was confirmed by the electrochemical analysis. All electrochemical measurements were performed by a three-electrode system in a 1.0 M KOH electrolyte, and the system was composed of a potentiostat (Bio-Logic VMP-3), a Pt wire as a counter electrode (CE), Ag/AgCl as a reference electrode (RE), and a glassy carbon electrode (GCE) having a diameter of 5 mm coated with each sample. The electrolyte was continuously purged with a nitrogen gas for deoxygenation, and the measurement was performed in the same environment as the ambient temperature.

For manufacturing the working electrode, 5 mg of the catalyst (Preparation Example 2 and Examples 1 to 7) was mixed with a solution of 0.75 ml of H₂O, 0.25 ml of 2-propanol, and 50 μl of a Nafion solution. The mixed suspension was sonicated for 30 minutes, and 11.55 μl of a catalyst ink was coated on a GCE having a diameter of 5 mm and dried in an oven.

A commercially available RuO₂ catalyst (20 mass %) supported on carbon black (Vulcan XC-72%) was coated on GCE in the same manner as the above to manufacture the working electrode, and the electrochemical properties were compared with the catalysts prepared above and analyzed, and the results are shown in FIG. 10.

As shown in (a) and (d) of FIG. 10, a linear sweep voltammetry (LSV) profile was measured by sweeping at a scan speed of 10 mV/s in a potential range of 1.2 to 1.7 V_{RHE} for evaluating the coated OER catalytic performance through a GCE electrode. When the OER activities of the synthesized catalyst were measured at an overpotential of 10 mA/cm², as seen in (d) of FIG. 10, the overpotential measured in Fe-5-NiT-24 (Example 6) had the lowest overpotential value of 292 mV, from which it was shown that OER occurred at a low potential energy and the electrochemical catalyst had excellent OER catalytic performance. Meanwhile, as shown in (a) of FIG. 10, the overpotential measured in NiT-24 (Example 3) was 355 mV which was lower than the commercially available RuO₂ catalyst supported on carbon black having an overpotential value of 365 mV, and in the other examples also, the OER catalytic performance was equivalent to or higher than the commercially available RuO₂ catalyst supported on carbon black.

(b) and (e) of FIG. 10 show the results of cyclic voltammetry (CV) experimentation of the sampled prepared above. It was performed in a potential range of 0.8 to 1.65 V_{RHE} at a scan speed of 50 mV/s. As shown in (b) of FIG. 10, the unique (identical) oxidation and reduction peaks in the NiT-x sample were observed at 1.45 and 1.3 V (versus RHE), respectively, and the unique oxidation-reduction (redox) peak as such was due to the redox reaction occurring between Ni²⁺ and Ni³⁺ in the nanosheet of Ni(OH)₂. However, as compared with the CV results of Fe-5-NiT-24 of (e) of FIG. 10, it was confirmed that the specific redox peak of oxidation and reduction of Fe-7-NiT-24 caused by Ni(OH)₂ and NiOOH was shifted to a higher potential. This was the result of suppressing the electrochemical oxidation of Ni(OH)₂, and by including Fe in the electrolyte, the peak area was decreased, while the peak of the Ni(OH)₂ and NiOOH redox couple was shifted to a higher potential.

In order to review the resistance value of the synthesized catalysts, the electrochemical impedance spectroscopic (EIS) measurement was performed at 1.6 V_{RHE} at an amplitude of 10 mV in a frequency range of 10 mHz-200 kHz. The EIS Nyquist graph was fitted to measure the solution resistance (Rₛ) and the charge transfer resistance (R_{ct}) occurring in OER occurrence. The measured resistance values are summarized in the following Table 3. As shown in (c) of FIG. 10, it was confirmed that R_{ct} of NiT-6, NiT-12, and NiT-24 had values of 25.03Ω, 22.41Ω, and 22.41Ω. Based on the result, since the active site was increased depending on the Ni(OH)₂ growth degree in the OER catalyst, it was shown that the movement of charge carriers was promoted in the boundary of the catalyst and the electrolyte. Referring to (f) of FIG. 10, it was shown that R ct of Fe-5-NiT-24 had the smallest resistance value of 17.23Ω, and the mobility of charge carriers was higher in the boundary between the catalyst and the electrolyte due to the activation of Fe.

TABLE 3

| Sample name | Rₛ (Ω) | R_{ct} (Ω) |
|---|---|---|
| RuO₂/VC | 5.32 | 18.59 |
| TiO | 5.74 | — |
| NiT-6 | 5.72 | 25.03 |
| NiT-12 | 5.58 | 22.41 |
| NiT-24 | 5.38 | 19.41 |
| Fe-0.1-NiT-24 | 5.24 | 19.04 |
| Fe-1-NiT-24 | 5.19 | 18.32 |
| Fe-5-NiT-24 | 4.85 | 17.23 |
| Fe-7-NiT-24 | 4.82 | 17.24 |

### Experimental Example 6

### Evaluation of Durability of Each Sample

In order to confirm the stability of the prepared catalyst and catalyst support, the catalyst inks of commercially available RuO₂, TiO, NiT-24, Fe-5-NiT-24, and Fe-5-Ni/VC which were prepared in the same manner as the catalyst ink prepared for evaluating OER performance were coated on a nickel foam (NF) to manufacture working electrodes. The nickel foam was sonicated in a mixed solution of ethanol and H₂O at a volume ratio of 1:1, washed with water, and stored in ethanol. Thereafter, 860 μl of the catalyst ink was dropped on the nickel foam of 0.5 cm² and dried at room temperature.

The overpotential at a point of 10 mA/cm² measured by performing the same method as the LSV profile measurement was observed to have the lowest overpotential of 270 mV in Fe-5-NiT-24, as shown in (a) of FIG. 11, and the value was found to be a lower value than the overpotential value (292 mV) of the electrode manufactured by coating GCE with the working electrode, which is due to the fact that additional activation was caused by the nickel foam itself.

For durability evaluation of the catalyst and catalyst support, the catalyst support corrosion experiment was performed by the methods of chronoamperometry and accelerated degradation test (ADT). The chronoamperometry was performed by measuring the overpotential at a point of 10 mA/cm² for 100 hours, and the catalyst support corrosion test was performed by scanning 30000 cycles at a scan speed of 100 mV/s in a potential range of 1.0 to 1.6 V_{RHE}.

As shown in (b) of FIG. 11, it was observed that Fe-5-NiT-24 had excellent stability so that the current density at a point of 10mA/cm² was decreased by 0.8% for 100 hours, that is, maintained the catalytic performance of 99.2% for 100 hours. However, it was observed that the RuO₂ catalyst supported on carbon black had instability so that the current density at a point of 10 mA/cm² was decreased by 45.1% for 50 hours, that is, maintained the catalytic performance of only 54.9% for 50 hours.

In addition, as shown in (a) of FIG. 12, it was observed that Fe-5-NiT-24 had almost the same OER performance even after 30000 cycles of ADT as before 3000 cycles of ADT. However, it was confirmed that the commercially available RuO₂ and Fe-5-Ni/VC (Comparative Example 1) having carbon as a support had significantly deteriorated OER catalytic performance. This showed that since carbon corrosion occurs at a lower potential than the OER potential energy, the carbon support was corroded during 30000 cycles of ADT.

Upon comparison of XRD patterns of Fe-5-NiT-24 having TiO as a support, Fe-5-Ni/VC having carbon black as a support, and commercially available RuO₂ catalyst supported on carbon black before after 30000 cycles of ADT ((b) of FIG. 12), Fe-5-NiT-24 included the nickel foam coated with the catalyst even after 30000 cycles of ADT and the peaks of the TiO support and β-Ni(OH)₂ were observed, and thus, it was confirmed that the Fe-5-NiT-24 catalyst supported on TiO was stably bound on the nickel foam. However, in the commercially available RuO₂ catalyst supported on carbon black (Vulcan XC-72R), only the peak of the nickel foam was observed after 30000 cycles of ADT and it was shown that the carbon support was corroded, and in the Fe-5-Ni/VC catalyst also, the carbon black carbon support was oxidized and only the peak of the nickel foam was observed after 30000 cycles of ADT. This was visually observed as shown in FIG. 13.

In order to confirm the corrosion due to the oxidation of the carbon support, XPS analysis depending on before/after 30000 cycles of ADT was further performed. FIG. 14 is drawings illustrating XPS spectra before and after 30000 cycles of ADT of the RuO₂ catalyst supported on carbon black and Fe-5-Ni/VC.

In the RuO₂ catalyst supported on carbon black, a C—C bond (284.8 eV) due to the carbon black in a C is spectrum was initially confirmed, but the C—C bond was greatly decreased due to a large amount of the carbon corrosion, so that a O—C═O bond which is a carbon oxide (289.1 eV) and a C—O bond (286.1 eV) remained, as shown in (a) of FIG. 14. The support collapse due to the oxidation of the carbon black catalyst support refers to the desorption of the RuO₂ catalyst which was the active site, and the change in the Ru 3p peak which disappeared after ADT was confirmed in (b) of FIG. 14.

It was confirmed in Fe-5-Ni/VC catalyst supported on carbon black also that the carbon oxide peak due to the carbon corrosion was shown in the C is spectrum of Fe-5-Ni/VC of (c) of FIG. 14, and Fe as the active site also showed that most of the peaks of Fe 2p disappeared, as shown in (d) of FIG. 14.

It was confirmed that the active site Ni initially dominantly had a Ni³⁺ peak by highly OER reactive β-NiOOH ((e) of FIG. 14), but the Ni²⁺ peak was dominant after ADT, which was considered as a peak due to the exposure of the nickel foam used as a current collector.

In addition, it was observed that the Ni—O—H bond (531.0 eV) was decreased for the same reason in the 0 1s spectrum of (f) of FIG. 14, but was maintained to some extent by the nickel foam itself, and the Ni—O bond (529.0 eV) by β-NiOOH was lost and greatly decreased by the oxidation of the carbon black carrier.

Additionally, for evaluating the durability of the catalyst and the catalyst support, overpotential at a point of 50 mA/cm² was measured for 100 hours by chronoamperometry, and as shown in FIG. 15, it was observed that Fe-5-NiT-24 had excellent stability so that the current density at a point of 50mA/cm² was decreased by 5.7% for 20 hours, that is, the catalytic performance of 94.3% was maintained for 20 hours. However, RuO₂/VC supported on the carbon black carbon support had a current density decreased by 74.6% and it was confirmed that the OER catalytic performance was significantly decreased by the loss of the active catalyst due to the oxidation of the carbon support.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present invention should not be limited to the above-described exemplary embodiments, and the following claims as well as all modifications equal or equivalent to the claims are intended to fall within the scope and spirit of the invention.

1. A porous catalyst for oxygen evolution reaction (OER) comprising:
a porous titanium oxide support satisfying TiO₂₋ₓ (0.1≤x<2); and
a metal hydroxide supported on the titanium oxide support.

2. The catalyst for oxygen evolution reaction of claim 1, wherein the titanium oxide support can be a cubic crystal phase.

3. The catalyst for oxygen evolution reaction of claim 2, wherein an electrical conductivity of the titanium oxide support at a pressure of 20 MPa is 2 to 10 S/cm.

4. The catalyst for oxygen evolution reaction of claim 1, wherein the titanium oxide support satisfies TiO₂₋ₓ (0.7≤x≤1.3).

5. The catalyst for oxygen evolution reaction of claim 1, wherein the metal hydroxide is plate-shaped and loaded on the titanium oxide support.

6. The catalyst for oxygen evolution reaction of claim 5, wherein the metal hydroxide is a hydroxide of a divalent metal.

7. The catalyst for oxygen evolution reaction of claim 6, wherein the divalent metal is one or more selected from Ca, Mg, Ni, Mo, Ru, Ir, Mn, Zn, Fe, Co, and Cu.

8. The catalyst for oxygen evolution reaction of claim 5, wherein the metal hydroxide can be a metal layered double hydroxide (LDH) composite.

9. The catalyst for oxygen evolution reaction of claim 8, wherein the metal layered double hydroxide composite contains a divalent metal and a trivalent metal.

10. The catalyst for oxygen evolution reaction of claim 9, wherein the catalyst for oxygen evolution reaction contains 7 to 30 atom % of the divalent metal and the trivalent metal.

11. The catalyst for oxygen evolution reaction of claim 10, wherein an atomic ratio of the divalent metal:the trivalent metal contained in the catalyst for oxygen evolution reaction is 1:0.01 to 0.5.

12. The catalyst for oxygen evolution reaction of claim 11, wherein the catalyst for oxygen evolution reaction maintains catalytic performance of 90% or more for 100-hour reaction at a fix potential and after an accelerated degradation test (ADT) of 30000 cycles.

13. The catalyst for oxygen evolution reaction of claim 11, wherein the catalyst for oxygen evolution reaction maintains catalytic performance of 90% or more for 20 hours at a potential to which a high current density based on 50 mA/cm² is applied.

14. A method of preparing a catalyst for oxygen evolution reaction, the method comprising:
(a) preparing a composite formed of a porous reduced titanium oxide support satisfying TiO₂₋ₓ (0.1≤x<2) and a metal (1) oxide in which a metal (1) is oxidized by a thermal reduction method from a mixture of anatase phase titanium dioxide (a-TiO₂) and the metal (1) as a reducing agent;
(b) reacting the composite with an aqueous solution including an ion of a metal (2) having oxygen evolution reaction activity to prepare a metal (2) hydroxide supported on the reduced titanium oxide support by a hydration reaction of the metal (1) oxide and an ion exchange reaction between metals.

15. The method of preparing a catalyst for oxygen evolution reaction of claim 14, wherein in (b), the metal (2) hydroxide grows inside through pore channels in the titanium oxide support.

16. The method of preparing a catalyst for oxygen evolution reaction of claim 14, wherein the metal (1) as the reducing agent is one or more selected from the group consisting of Mg, Al, Mn, Ca, Sn, Zn, Sb, Ag, Cu, Ni, Fe, Co, and Si.

17. The method of preparing a catalyst for oxygen evolution reaction of claim 16, wherein the thermal reduction method is performed at 300 to 1500° C.

18. The method of preparing a catalyst for oxygen evolution reaction of claim 14, wherein the titanium oxide support satisfies a cubic crystal phase TiO₂₋ₓ (0.7≤x≤1.3).

19. The method of preparing a catalyst for oxygen evolution reaction of claim 14, wherein the ion of the metal (2) included in the aqueous solution in (b) is an ion of a divalent metal.

20. The method of preparing a catalyst for oxygen evolution reaction of claim 19, wherein the ion of the divalent metal includes one or more metal cations selected from Ca²⁺, Mg²⁺, Mo²⁺, Ru²⁺, Ir²⁺, Ni²⁺, Mn²⁺, Zn²⁺, Fe²⁺, Co²⁺, Pd²⁺, Pt²⁺ and Cu²⁺.

21. The method of preparing a catalyst for oxygen evolution reaction of claim 20, wherein the ion exchange reaction is performed for 1 to 48 hours so that a plate-shaped metal (2) hydroxide grows.

22. The method of preparing a catalyst for oxygen evolution reaction of claim 21, wherein the hydration reaction, the ion exchange reaction, and the growth of the metal (2) hydroxide in (b) are performed in-situ.

23. The method of preparing a catalyst for oxygen evolution reaction of claim 14, further comprising: after (b), doping the metal (2) hydroxide supported on the titanium oxide support with divalent and trivalent metal (3) ions.

24. The method of preparing a catalyst for oxygen evolution reaction of claim 23, wherein the doping with the divalent and trivalent metal (3) ions is performed by an electrochemical activation process.

25. The method of preparing a catalyst for oxygen evolution reaction of claim 24, wherein a metal layered double hydroxide (LDH) composite is supported on the titanium oxide support by the doping with divalent and trivalent metal (3) ions.
